(19) United States
(12) Patent Application Publication
(10) Pub. No.: US 2013/0007149 A1
(43) Pub. Date: Jan. 3, 2013

(54) Social network with secret statuses and Verifications

(76) Inventor: Scott C. Harris, Rancho Santa Fe, CA (US)

(21) Appl. No.: 13/400,083

(22) Filed: Feb. 19, 2012

Related U.S. Application Data
(60) Provisional application No. 61/445,194, filed on Feb. 22, 2011.
(60) Provisional application No. 61/445,202, filed on Feb. 22, 2011.

(51) Int. Cl. G06F 15/16

(52) U.S. Cl. 709/206

(57) ABSTRACT

User profiles are on a social networking site, and that profile includes three different parts: a public part, a private part only to be shown to friends of the user, and a personal private part that is not shown to anyone who does not meet the specified criteria, whether friends or not friends. That other private part can be, for example, information about personal or dating preferences, that is only shown to those people who expressed similar desire to see personal or dating preferences. In one embodiment, the users profile is verified before showing them anyone else's private information.

This application claims priority from application No. 61,445,194, filed Feb. 22, 2011, and entitled “Social network with secret statuses”, and application No. 61,445,202 entitled “Verification on a Social Network”, and filed Feb. 22, 2011, the entire contents of both of which are herewith incorporated by reference.

### BACKGROUND

Social networks such as Facebook are intended for friends to meet up. Other social networks, such as dating sites including match.com and others have a very loyal following. However, many people assign a stigma to the dating sites, and will not participate or join because of that stigma.

Other sites that attempt to find friends among adults are believed by many to be sites that are fronts for pornography and/or prostitution. Any site that attempts to add these kinds of features often becomes labeled as a porn site. Sites such as MySpace and Facebook have steered away from matchups of these kinds.

### SUMMARY

The present application describes a way that a social network can provide information about people who are interested in mates, without providing parts of the stigma associated with dating sites.

### BRIEF DESCRIPTION OF THE DRAWINGS

The different figures show different embodiments.

FIG. 1 shows a public page;

FIG. 2 shows a status setting page;

FIG. 3 shows a private page;

FIG. 4 shows a verification scheme; and

FIG. 5 shows a personal knowledge based verification scheme.

### DETAILED DESCRIPTION

The present invention recognizes that certain advantages can be obtained by having a social networking site that has both a public part of the site and a private part of the site that can only be accessed with certain criteria. The public part of the site may itself be in multiple different forms, in a similar way to how “Facebook” carries out its operation. In the Facebook site, for example, there may be a public part of the profile that can be seen by anyone, and then other parts of the profile might only be seen by friends. However, many times people have hundreds or thousands of friends, and all the friends can see the entire profile.

FIG. 1 illustrates an embodiment which has a conventional public site/page 100 which shows the users name 102, their status 104, names of friends 106, and picture 108. This may be a conventional type of site that shows these different items as well as other similar information. As conventional, this may show a different amount of information to friends than it shows to non-friends.

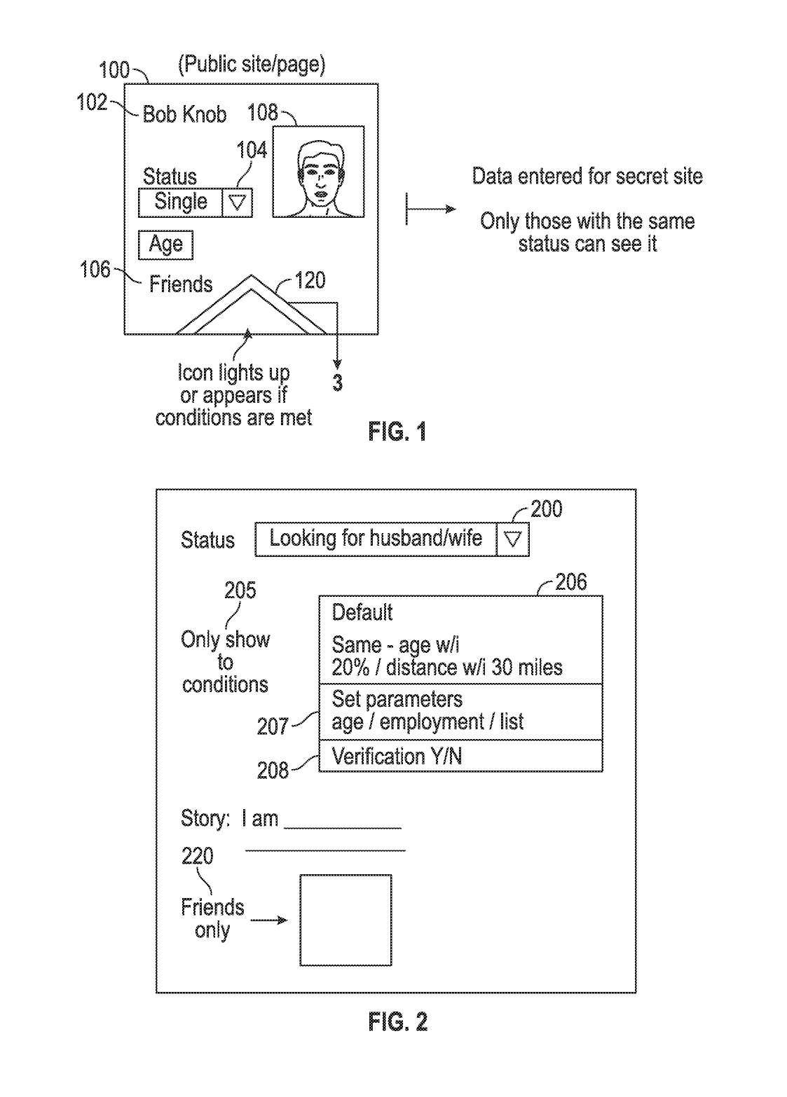

The user also can set preferences as shown in FIG. 2. These preferences are treated by the system as secret preferences that are used by the system to match to someone else's secret preferences.

Once setting the preferences in FIG. 2, only those users who have the same preference can see the private part of that user's profile.

FIG. 2 for example shows one of the secret statuses as being “looking for a husband/wife”. The user can set the secret status 200, and can also set special “only show to” conditions at 205. One of the “only show to condition” can be, for example, default 206, where the default can be a user who has the same kinds of characteristics in their secret status, for example here the default might be secret status as looking for husband/wife, age within 20% (that is if the user is 35, the age can be 20% less or 28 or 20% more or 42), and living distance within 30 miles. The system uses the secret status to determine what other users can see that or other secret statuses. Only users with that same profile are enabled to see the secret status, so even “friends” of the user listed in page 100 does not see that secret part.

In one embodiment, the secret status can be a status that enables users to see other statuses. For example, the secret status of “looking for a husband wife” might not be shown to others, but might only allow others to have that same secret status to see other things in the profile, such as likes/dislikes, family preferences, etc.

207 shows an alternative embodiment in which the parameters can be specifically set, for example allowing the user can set specific ages, specific kinds of employment that you want, specific distances and the like.

208 indicates a verification. The present application contemplates that certain people might create profiles for no reason other than to see other secret profiles. 208 can require a verification of the person's status. In one embodiment, for example, this can require a third-party verification by an actual third person, or by a trusted friend. For example, the verification may verify that the person is who they say they are. Another verification can be that the person is really “looking” in the way they say they are (e.g., is the person really unmarried).

The verification may use the techniques described below.

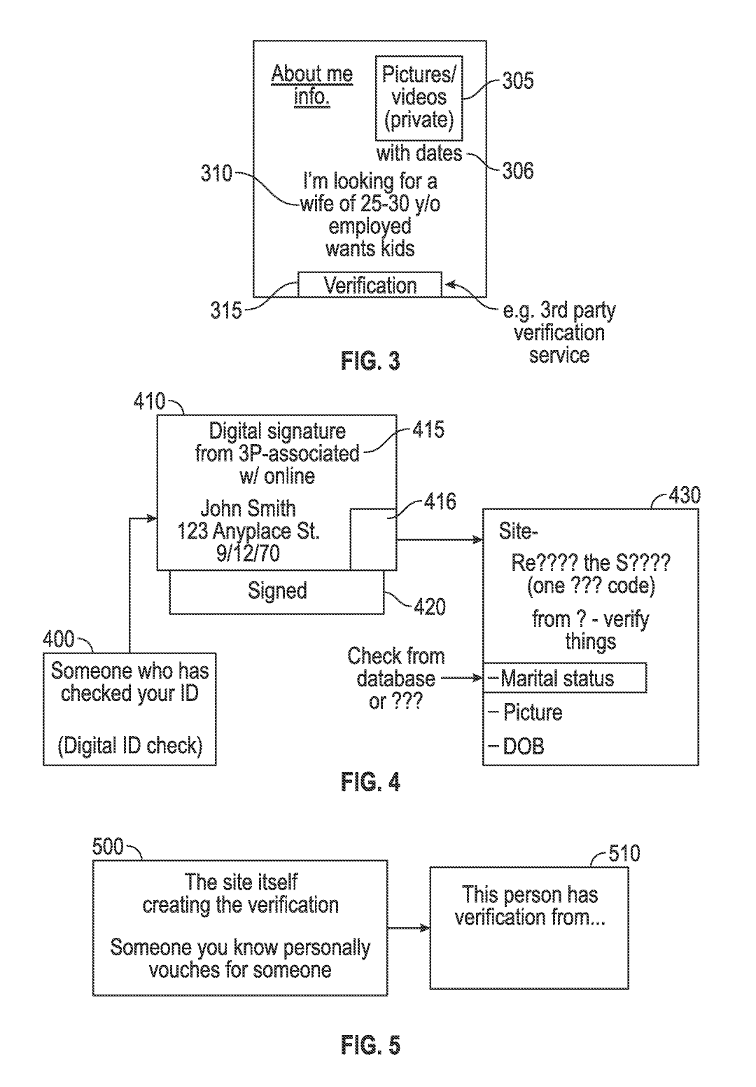

When the user status matches according to the rules, a special icon shown as 120 lights up on the public site/page being viewed by that user whose status matches. That icon does not exist unless the “only show to” conditions are met. That is, when the user status matches the specific status of the private/secret site, the icon lights up. The user selecting the icon receives the page shown in FIG. 3, which is the secret page shown only to those who match the status. This may include private pictures and videos 305 which can be pictures and videos of any type. In one embodiment, those pictures are dated as shown in 306, so that a user ensures that the pictures received are not very old.

Area 310 indicates a wish list which has been entered by the user whose profile is being viewed. In this embodiment, the user indicates that they are looking for a wife between 25 and 30 years old, employed who wants kids.

315 indicates the verification, where the verification can be a third-party verification service that actually requires a person to verify themselves using ID or the like, or can be a verification service of trusted friends, or can be the verification described below in FIGS. 4-5.

Other statuses can also be used. For example, there can be a special page for FTF friends only, shown as 220 in FIG. 2. That page for friends may be only for those that a user personally knows and has verified.

Verification can be used on the social network to produce certain security in a social network. There have been well-publicized problems caused by people on social networks lying about some aspect of who they are. For example, sex offenders have been on networks, and people who were one age have masqueraded as people who are in other age group.

Before a user releases private information as in the above, it may be advantageous to verify that that person is telling the truth before allowing them to show that profile.

This embodiment may therefore have user profiles on a social networking site, with three different parts: a public part that can be shown to anyone, a private part only to be shown to friends of the user, and a personal private part that is not shown to anyone who does not meet the specified criteria, whether friends or not friends. That other private part can be, in one embodiment, information about personal or dating preferences, that is only shown to those people who expressed similar desire to see personal or dating preferences. That way, those who have not indicated that they are looking for dating matches will not be able to see that other people are seeking such matches. Even if the users are friends, they will not see the dating information.

In another embodiment, the personal/dating information may only be shown to non-friends. This ensures that no one within the user's circle of friends can see the user's personal/dating preferences, even of those people who have matching preferences. That way, all of the user's friends are not shown the dating preferences. This removes more of the stigma associated with hosting dating information, since the user's friends, will not know that the user has posted dating information at all.

In one embodiment, the user's profile is verified before showing them anyone else's private information.

An embodiment describes new ways of techniques if verifying that a virtual person is who they say they are, over the internet, e.g., in a social networking environment.

A first verification embodiment shown in FIG. 4 may involve verifying an online user, via a third-party. A third-party can provide a digital signature indicative of a trusted third-party verification service. For example, verification services may post bonds or provide other kinds of assurances that they are actually doing what they say they're going to do. The digital signature may be obtained by a user going to or otherwise visiting a verification service at 400. The verification service may check the user's ID, and find other information about the user. At least the name and address and age can be verified from the ID check.

The user who was ID-checked is provided with a digital signature at 410 which includes a first part 415 that includes information that was associated with their ID that was actually checked, along with a signature 420 that cryptographically verifies that the information in the digital signature is actually accurate.

For example, the information part 415 may verify that the user is John Smith at 123 Any Place Way and that they were born on Sep. 12, 1970. This can be used, therefore, to verify the person's name address and age. The verification may also include a photo 416 that is taken of the person as of that date, and where that photo is digitized. The identification part may also include any other kind of information that can be actually verified.

A person has verified this information, from ID or a face to face meeting with the person. The digital signature 420 verifies cryptographically that the information in the information part 415 is correct according to that person. According to one embodiment, the signature 420 may include a hash of the digital information in the information part 415 so that the user cannot change the information in the information part 415.

The verification information can be read by the site at 430. The site then reads the information part, and verifies that the digital signature 420 matches the information part. This can be done, for example, using a one-way code or any other cryptographic technique.

As an alternative, the information part can be packaged in a read only format so that it cannot be modified, and the read-only format can be indicated as authentic by a certificate or the like.

The above describes how the users name, address, age can be verified from their ID. However, it may be desirable to verify other things such as marital status and/or criminal records. One way of doing this is to verify this from a background check of the user. The site 400 for example can do a background check, and add that to the digital signature. According to another embodiment, the marital status can be determined from publicly available database information.

According to another embodiment, the site itself can create the verification by a system of vouching. For example, you may vouch for someone you know personally, as being that person, having the look in the picture, being that age, as well as anything else about the person including marital status, criminal record, and the like. People you actually know may trust your vouching. Conversely, you may trust the vouching of someone else. For example, if your best friend knows somebody, they may provide a vouch of that person that the person really looks like the picture on the site, that they are really the same age, that they really have the same name, that they are really single and not married, or something else.

FIG. 5 shows this personal vouching technique in 500, where a person personally vouches for someone else. The site then shows at 510 who has vouched for that person.

This can be extended to degrees of separation, where friends of friends can also vouch for someone else, where you can vouch for someone as being a trusted person and then that person vouches for someone else. In one embodiment the vouching may be confidential, so that you vouch for someone else but it is confidential vouching, where the site gives a result of different people vouching and what they said. The site might, for example say someone you know very well has vouched for this person but says that they don't look exactly like they are in the picture, or that this picture is five years old.

According to another embodiment, there may be different statuses associated with the vouching, where you vouch for people and indicate the basis for your vouching. For example, you could vouch for a person by saying “this is my sister”. Other people on the social networking site can then see the you have vouched for someone who you know very well. However the question then is—who are you and are you making this up?

However perhaps you can find someone who knows you and you know someone else.

You could also vouch for someone by saying I have known this person for a week, a month, a year, five years, 10, 20 years, etc. You can vouch for someone by saying I have met this person face-to-face without specifically saying anything else other than they appear to be who they say they are.

According to one embodiment, you can also vouch for a person's employment status, for example this person works at Bob's pizza.

Another embodiment may show on the social networking site, information about how you met. For example you may have friended a friend online, but it may be someone you know face-to-face. People on the site that you know face-to-face have greater are more likely to be real and less likely to be fakes. Therefore, a verification determination can be implied when you have 20 friends on the social networking site who know you face-to-face. Of course, this can be fooled by providing many different people who lie about the face-to-face knowledge.

Other verification techniques are also contemplated.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

For example other information can be displayed on these pages, where that other information is handled according to the techniques described herein. Other kinds of sites can be modified and used with these techniques.

Certain kinds of computers are disclosed, but other computers, both server and client, are contemplated to be within this disclosure.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of operating a social networking site, comprising:
storing profiles of multiple users on a social networking website, said profiles including information about each of said users;
storing friend preferences of said multiple users on said social networking site;
showing first content from multiple users automatically to friends of the multiple users, and not showing said first content to users who are not friends of the multiple users, said showing comprising each user seeing said first content of only for users who are friends of the each user;
storing second content about each of the multiple users representing private information which is not automatically shown to said friends of the multiple users; and
comparing said second content to second content associated with other users, and based on a result of said comparing, determining whether said second content will be shown to any other user, where said second content for a second user is only shown to a first user when said second content of said second user matches in a specified way to said second content of said first user, based on said comparing.

2. The method as in claim 1, wherein said second content includes information about dating preferences.

3. The method as in claim 1, wherein said second content is given only to people on the website who are not friends of the second user and who also have said second content matching to said first content in the specified way based on said comparing.

4. The method as in claim 1, wherein said specified way comprises said second content matching completely to said first content.

5. The method as in claim 1, further comprising verifying at least one aspect of a profile of said first user, and only providing said second content to said first user when said aspect of said profile is verified.

6. The method as in claim 5, wherein said verification requires a digital signature from an authority that has actually verified the first user's identity.

7. The method as in claim 2, further comprising verifying a martial status of said first user from an additional source other than from said first user, prior to providing said second content to said first user.

8. The method as in claim 1, further comprising displaying a special icon to said first user only when said second content of said second user matches in a specified way to said second content of said first user, based on said comparing.

9. A social networking website, comprising:
a computer server storing profiles of multiple users on a social networking website, said profiles including information about each of said users, said computer server also storing friend preferences of said multiple users on such social networking site,
said profiles for each of plural users including at least a public part that can be shown to any other user, a friend private part for each user that is only shown to friends of the each user, and a personal private part, separate from said friend private part, that is only shown to first users who match a specified criteria for the each user, where said specified criteria is other than whether said each user is a friend of the first user.

10. The website as in claim 9, wherein said computer server stores said personal private part as including information about dating preferences, that is only shown to those people who also include information in said personal private part that matches said dating preferences.

11. The website as in claim 9, wherein said personal private part is given only to people on the website who are not friends of the first user and who also have said personal private part matching to said specified criteria in a specified way based on said computer server comparing using said specified criteria.

12. The website as in claim 11, wherein said specified way comprises said personal private part matching completely to said specified criteria.

13. The website as in claim 9, further comprising verifying at least one aspect of a profile of a first user, and only providing said personal private part to said first user when said aspect of said profile is verified.

14. The website as in claim 10, further comprising obtaining in the computer server, an verification from an additional source , other than from said first user, of a marital status of a first user as a condition to providing said personal private part.

15. A social networking site, comprising:
a computer server storing profiles of multiple users, said profiles including information about each of said users, and storing friend preferences of said multiple users on said social networking site, said computer server automatically showing first content from multiple users automatically to friends of the multiple users, and not showing said first content to users who are not friends of the multiple users, said showing comprising showing each user said first content only for users who are friends of the each user,
said computer server also storing second content about each of the multiple users representing private information which is not automatically shown to said friends of the multiple users; and
said computer server comparing said second content to second content associated with other users, and determining whether said second content will be shown to any other user based on a result of said comparing, where said second content for a second user is only shown to a first user when said second content of said second user matches in a specified way to said second content of said first user, based on said comparing.

16. The site as in claim 15, wherein said second content includes information about dating preferences.

17. The site as in claim 15, wherein said computer server gives said second content only to people on the site who are not friends of the second user and who also have said second content matching to said first content in the specified way based on said comparing.

18. The site as in claim 15, further comprising verifying at least one aspect of a profile of said first user, and only providing said content to said first user when said aspect of said profile is verified.

19. The site as in claim 16, further comprising obtaining in the computer server, an verification from an additional source, other than from said first user, of at least a marital status within a profile of said first user, and only providing said content to said first user when said marital status is verified.
